(19) United States
(12) Patent Application Publication
(10) Pub. No.: US 2017/0297274 A1
(43) Pub. Date: Oct. 19, 2017

(54) HYBRID LONG FIBER THERMOPLASTIC COMPOSITES

(71) Applicant: OCV Intellectual Capital, LLC, Toledo, OH (US)

(72) Inventor: David R. Hartman, Granville, OH (US)

(21) Appl. No.: 15/516,716

(22) PCT Filed: Oct. 8, 2015
(86) PCT No.: PCT/US2015/054586

§ 371 Date: Apr. 4, 2017

Related U.S. Application Data
(60) Provisional application No. 62/061,323, filed on Oct. 8, 2014.

(51) Int. Cl. B29C 70/08; B29B 9/06; B29C 70/50; B29K 307/04; B29K 77/00; B29L 31/30; B29K 309/08

(52) U.S. Cl. CPC B29C 70/08; B29C 70/50; B29B 9/06; B29K 2309/08; B29K 2077/00; B29K 2995/0077; B29L 2031/30; B29K 2307/04

(57) ABSTRACT

A hybrid reinforcement material (18) is disclosed that includes a plurality of reinforcement fibers (12) and a plurality of carbon fibers (14) comingled with the reinforcement fibers (12). The reinforcement fibers (12) are selected from natural fibers, organic fibers, and inorganic fibers and form a single hybrid assembled roving with the carbon fibers (14). The carbon fibers (14) are post-coated with a compatibilizer. The hybrid assembled roving (18) may be formed using a hybrid of glass and carbon fibers.

This application claims priority to and all benefit of U.S. Provisional Patent Application Ser. No. 62/061,323, filed on Oct. 8, 2014, for HYBRID ASSEMBLIES FOR IMPROVED COMPOSITE PERFORMANCE AND PRODUCTIVITY, the entire disclosure of which is fully incorporated herein by reference.

### BACKGROUND

Fiber reinforced composites are composite materials composed of a matrix material and fibers that function to mechanically enhance the strength and elasticity of the matrix material. Fiber reinforced composites have high stiffness, strength, and toughness, often comparable with structural metal alloys. Further, fiber reinforced composites usually provide these properties at substantially less weight than metals as their “specific” strength and modulus per unit weight approaches five times that of steel or aluminum. Consequently, the overall structure of a device formed from a fiber reinforced composite may be lighter. For weight-critical devices such as airplane or spacecraft parts, these weight savings might be a significant advantage.

Sheet molding compound (“SMC”) is a fiber reinforced thermoset compound in sheet form. Because of its high strength to weight ratio, it is widely used as a construction material. Its strength, stiffness, and other properties make it suitable for use in horizontal as well as vertical panels, for example, in automobiles. In an SMC production process, a layer of a polymer film, such as a polyester resin or vinyl ester resin premix, is metered onto a plastic carrier sheet that includes a non-adhering surface. Reinforcing fibers are then deposited onto the polymer film and a second, non-adhering carrier sheet containing a second layer of polymer film is positioned onto the first sheet such that the second polymer film contacts the reinforcing fibers and forms a sandwiched material. This sandwiched material is then continuously compacted to distribute the polymer resin matrix and fiber bundles throughout the resultant SMC material, which may then be rolled for later use in a molding process.

In the production of SMC compounds, it is desirable that the reinforcement materials homogeneously disperse and mix within the polymeric matrix material. One measure of this homogenous mixing is referred to as wetting, which is a measure of how well the reinforcement material is encapsulated by the matrix resin material. It is desirable to have the reinforcement material completely wet with no dry fibers. Incomplete wetting during this initial processing can adversely affect subsequent processing as well as the surface characteristics of the final composite. For example, poor wetting may result in poor molding characteristics of the SMC, resulting in surface defects and low composite strengths in the final molded part. The SMC manufacturing process throughput, such as line-speeds and productivity, are limited by how well and how quickly the roving chopped bundles can be fully wetted.

Composite products may also be formed using thermoplastic resins, such as long-fiber-reinforced thermoplastics (“LFT”) composites. LFT composites are thermoplastics having long (about 4.5 mm or greater) pieces of chopped fiber reinforcements. The difference between LFTs and conventional chopped, short fiber reinforced compounds lies in the length of the fibers. In LFTs, the length of the fiber is the same as the length of the pellet. In LFT manufacturing, continuous strands of fiber rovings are pulled through a die, where they are coated and impregnated with thermoplastic resin. This continuous rod of reinforced plastic is then chopped or pelletized, typically to lengths of 10 mm to 12 mm.

Glass fibers and carbon fibers are common examples of fiber reinforcements. Glass fibers provide dimensional stability as they do not shrink or stretch in response to changing atmospheric conditions and they provide dimensional tolerances similar to metals for part consolidation. In addition, glass fibers have high tensile strength, heat resistance, corrosion resistance, and high toughness for impact resistance and fastening or joining. Typically, glass fibers are formed by attenuating streams of a molten glass material from a bushing or other collection of orifices. An aqueous sizing composition containing a film forming polymer, a coupling agent, and a lubricant is typically applied to the fibers after they are drawn from the bushing to protect the fibers from breakage during subsequent processing and to improve the compatibility of the fibers with the matrix resins that are to be reinforced. After the sizing composition has been applied, the sized fibers are gathered into strands and wound to produce a glass fiber package. The glass fiber package is then heated to remove water and deposit the size as a residue lightly coating the surface of the glass fiber. Multiple dried glass fiber packages may be consolidated and wound onto a spool referred to as a multi-end roving package. The roving package is composed of a glass strand with multiple bundles of glass fibers.

Carbon fibers are lightweight fibers with desirable mechanical properties, which make them useful in forming composite materials with various matrix resins. On the one hand, carbon fibers demonstrate high tensile strength and high modulus of elasticity. On the other hand, carbon fibers exhibit high electric conductivity, high heat resistance, and chemical stability. This combination of properties, along with the low density of carbon fibers, has led to the increased use of carbon fibers as reinforcing elements in composite materials for a wide range of applications in industries as diverse as aerospace, transportation, electromagnetic interference (EMI) shielding applications, sporting goods, battery applications, thermal management applications, and many other applications.

However, carbon fibers are more difficult to process and are more costly than glass fibers. Carbon fibers can be brittle and are highly susceptible to entanglement with poor abrasion resistance and thus readily generate fuzz or broken threads during processing. Additionally, due at least in part to their hydrophobic nature, carbon fibers do not wet as easily as other reinforcement fibers, such as glass fibers, in traditional resin matrices. Wetting refers to the ability of the fibers to have appropriate surface wetting tension so as to homogenously disperse throughout the matrix. To utilize a composite material including carbon fibers, excellent wetting and adhesion between the carbon fibers and a matrix resin is important.

Glass and carbon fibers each impart desirable properties to fiber reinforced composites. Thus, blends of glass and carbon fibers in resins have been attempted to utilize the qualities of toughness, strength, and modulus that each provides to a resin matrix. However, in attempting such a hybrid composite, considerable difficulty has been encountered processing the carbon strands in fast curing and consolidation processes desirable for cost effective composites.

### SUMMARY

In accordance with additional aspects of the present invention, a hybrid long fiber thermoplastic material and method of forming a hybrid long fiber thermoplastic material are provided. The hybrid long fiber thermoplastic material includes a thermoplastic material and a hybrid assembled roving fully impregnated with the thermoplastic material. The hybrid assembled roving includes a plurality of reinforcement fibers and a plurality of carbon fibers comingled with the reinforcement fibers. The carbon fibers are post-coated with a compatibilizer prior to comingling with the reinforcement fibers.

In various exemplary embodiments, the reinforcement fibers are glass fibers.

In various exemplary embodiments, the compatibilizer comprises at least one of polyvinylpyrrolidone (PVP), methyl silane, amino silane, and epoxy silane.

In various exemplary embodiments, the hybrid long fiber thermoplastic material comprises chopped pellets having a length of about 10 to 12 mm.

In various exemplary embodiments, the carbon fibers have a density of 50 tex to 800 tex and a width of 0.5 mm to 4 mm.

In various exemplary embodiments, the hybrid reinforcement material has a width of 0.5 mm to 2 mm.

In various exemplary embodiments, the weight ratio of the glass fibers to the carbon fibers is within the range of 10:90 to 90:10.

In various exemplary embodiments, the hybrid reinforcement material has a specific strength of 1.0×10⁵ m to 2.0×10⁵ m, a specific modulus of 7.0×10⁶ m to 14.0×10⁶ m, a tensile strength of greater than 150 MPa, and a tensile modulus of greater than 15 GPa.

In accordance with various aspects of the present invention, an extruded hybrid charge for use in a compression molding process comprising hybrid long fiber thermoplastic material is provided.

### DESCRIPTION OF THE DRAWINGS

Exemplary embodiments of the disclosure will be apparent from the more particular description of certain example embodiments provided below and as illustrated in the accompanying drawings.

FIG. 1 illustrates a carbon fiber forming line starting from a precursor.

FIG. 2 illustrates an exemplary hybrid assembled roving forming process.

FIG. 3 illustrates an initial spreading station where the carbon fibers are pulled under tension to spread the carbon fibers into carbon fiber bundles.

FIGS. 4(a) and (b) illustrate a grooved roller for spreading carbon fiber bundles.

FIG. 5 illustrates another exemplary hybrid assembled roving forming process.

FIGS. 6(a)-(c) illustrate exemplary hybrid assembled roving formations, varying the placement of carbon bundles and glass fibers.

FIG. 7 illustrates an exemplary ridged roller used for chopping reinforcement fibers.

FIG. 8 illustrates an exemplary process for incorporating at least two types of reinforcement fibers onto a polymer resin film.

FIG. 9 illustrates the various types of carbon and glass fiber dispersion in a hybrid SMC composite material.

FIG. 10 graphically illustrates the specific strength of various types of fibers versus the specific modulus of the fibers.

FIG. 11 graphically illustrates a stress-strain curve for three SMC materials, one including only glass fiber reinforcements, one including only carbon fiber reinforcements, and one including hybrid assembled roving reinforcements having 50:50 glass to carbon ratio.

FIG. 12 graphically illustrates the tensile strength as a function of the chopped strand width of an exemplary hybrid SMC material compared to both glass and carbon reinforced SMC material.

### DETAILED DESCRIPTION

While the general inventive concepts are susceptible of embodiment in many different forms, there are shown in the drawings, and will be described herein in detail specific embodiments thereof with the understanding that the present disclosure is to be considered as an exemplification of the principles of the general inventive concepts. Accordingly, the general inventive concepts are not intended to be limited to the specific embodiments illustrated herein.

Unless otherwise defined, the terms used herein have the same meaning as commonly understood by one of ordinary skill in the art encompassing the general inventive concepts. The terminology used herein is for describing exemplary embodiments of the general inventive concepts only and is not intended to be limiting of the general inventive concepts. As used in the description of the general inventive concepts and the appended claims, the singular forms “a,” “an,” and “the” are intended to include the plural forms as well, unless the context clearly indicates otherwise.

The present invention relates to a hybrid reinforcement material for use in processing applications, such as, for example, 1) in the formation of a reinforced composite, (e.g. a sheet molding compound (“SMC”) for compression molding, 2) long fiber thermoplastic injection molding, 3) pultrusion process, 4) prepreg formation, and the like. The hybrid reinforced composites formed from the above processing applications include (i) comingled glass and carbon reinforcing material and (ii) a thermoset or thermoplastic resin composition.

The reinforcement material may include any type of fiber suitable for providing good structural qualities, as well as good thermal properties, to a resulting composite. The reinforcing fibers may be any type of organic, inorganic, or natural fibers. In some exemplary embodiments, the reinforcement fibers are made from any one or more of glass, carbon, polyesters, polyolefins, nylons, aramids, poly(phenylene sulfide), silicon carbide (SiC), boron nitride, and the like. In some exemplary embodiments, the reinforcement fibers include one or more of glass, carbon, and aramid. In some exemplary embodiments, the reinforcement material comprises a hybrid of glass and carbon fibers.

The glass fibers may be formed from any type of glass suitable for a particular application and/or desired product specifications, including conventional glasses. Non-exclusive examples of glass fibers include A-type glass fibers, C-type glass fibers, G-type glass fibers, E-type glass fibers, S-type glass fibers, E-CR-type glass fibers (e.g., Advantex® glass fibers commercially available from Owens Corning), R-type glass fibers, wool glass fibers, biosoluble glass fibers, and combinations thereof, which may be used as the reinforcing fiber. In some exemplary embodiments, the glass fiber input used in the hybrid reinforcement material is a multi-end glass roving material that has been assembled under a conventional offline roving process.

Carbon fibers are generally hydrophobic, conductive fibers that have high stiffness, high tensile strength, high temperature tolerance, low thermal expansion, and are generally light weight, making them popular in forming reinforced composites. However, carbon fibers are more expensive than other types of reinforcement material, such as glass. For instance, carbon fibers may cost upwards of $20/kg, while glass fibers may cost as low as about $1/kg. Additionally, carbon fibers are more difficult to process in downstream applications, which leads to slower product manufacturing. This is due at least in part to the hydrophobic nature of carbon fibers that do not wet as easily in traditional matrices as glass fibers. Wetting refers to the ability of the fibers have appropriate surface wetting tension and homogenously disperse throughout the matrix. In contrast, glass fibers, which are generally hydrophilic fibers, are easier to process and will wet homogenously in a matrix.

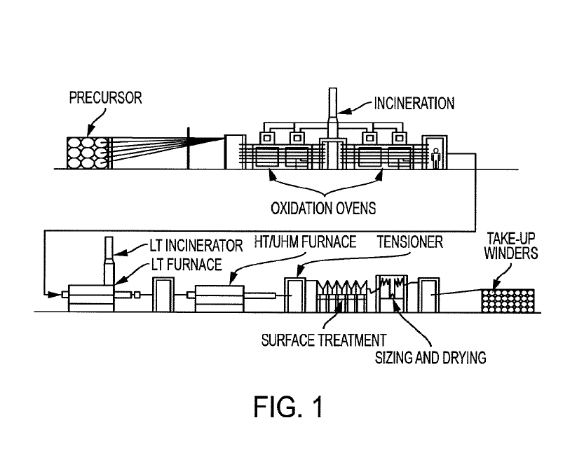

Depending upon the precursor used, carbon fibers may be turbostratic or graphitic, or have a hybrid structure with both turbostratic and graphitic parts present. In turbostratic carbon fiber, the sheets of carbon atoms are haphazardly folded, or crumpled, together. Graphitic carbon fibers derived from polyacrylonitrile (PAN) are turbostratic, whereas carbon fibers derived from mesophase pitch are graphitic after heat treatment at temperatures exceeding 2200° C. In some exemplary embodiments, the carbon fibers are derived from PAN. FIG. 1 illustrates one exemplary process for forming a carbon roving from a PAN precursor.

The reinforcement fibers may be coated with a sizing composition during or immediately following the fiber formation process. In some exemplary embodiments, the sizing composition is an aqueous-based composition, such as a suspension or emulsion. The suspension or emulsion has a solids content comprising one or more of a film former, a coupling agent, a lubricant, and a surfactant. The film former holds individual filaments together to aid in the formation fibers and protects the filaments from damage caused by abrasion. Acceptable film formers include, for example, polyvinyl acetates, polyurethanes, modified polyolefins, polyesters, epoxides, and mixtures thereof.

The sizing composition may further include at least one coupling agent, such as a silane coupling agent. Silane coupling agents function to enhance the adhesion of the film forming polymers to the fibers and to reduce the level of fuzz, or broken fiber filaments, during subsequent processing. Examples of silane coupling agents, which may be used in the present size composition, may be characterized by the functional groups amino, epoxy, vinyl, methacryloxy, azido, ureido, and isocyanato. The coupling agent may be present in the size composition in an amount of from about 0.05% to about 0.20% active solids, and more preferably in an amount of from about 0.08% to about 0.15% active solids.

The sizing composition may also contain at least one lubricant. Any conventional lubricant may be incorporated into the size composition. Non-exclusive examples of lubricants suitable for use in the size composition include, but are not limited to, partially amidated long-chain polyalkylene imines, ethyleneglycol oleates, ethoxylated fatty amines, glycerine, emulsified mineral oils, organopolysiloxane emulsions, a stearic ethanolamide, and water-soluble ethyleneglycol stearates such as polyethyleneglycol monostearate, butoxyethyl stearate, and polyethylene glycol monooleate. The lubricant may be present in an amount of from about 0.025% to about 0.010% active solids.

In addition, the size composition may optionally include a pH adjusting agent, such as acetic acid, citric acid, sulfuric acid, or phosphoric acid to adjust the pH level of the composition. The pH may be adjusted depending on the intended application, or to facilitate the compatibility of the ingredients of the size composition. In some examples, the sizing composition has a pH of from 3.0-7.0, or a pH of from 3.5-4.5.

Additional additives may be included in the sizing compositions, depending on the intended application.

In some exemplary embodiments, two or more types of reinforcement fibers are comingled in formation of a hybrid assembled roving. A hybrid assembled roving is a multi-end fiber roving comprising at least two types of reinforcement fibers. For example, the hybrid assembled roving may comprise two or more of glass fibers, carbon fibers, aramid fibers, and high modulus organic fibers. In some exemplary embodiments, the hybrid assembled roving comprises a mixture of glass and carbon fibers. Although the hybrid reinforcement fibers will be described herein as mixture of glass and carbon fibers, it is to be understood that such is only one exemplary embodiment, and the hybrid assembled roving may comprise any combination of reinforcement fibers discussed above.

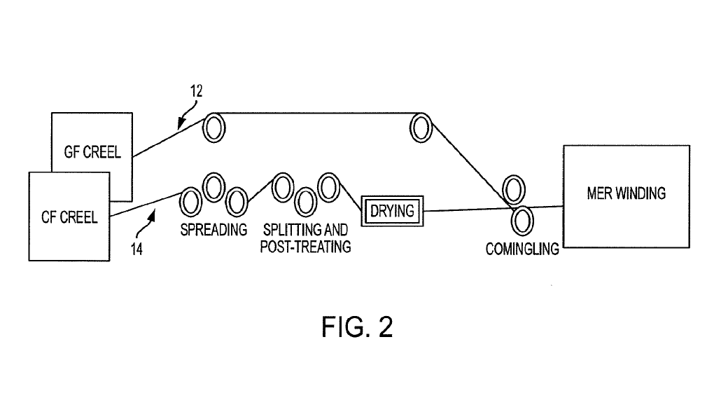

Forming the hybrid assembled roving may occur in a number of ways. For instance, FIG. 2 illustrates a forming process in which glass strands 12 and carbon strands 14 are separately tensioned and the glass strands are pulled into the carbon processing line, which comingles the glass and carbon strands 15 prior to winding the comingled strands 17 into a single hybrid assembled roving package 28. In some exemplary embodiments, the glass strands are incorporated into the carbon fiber processing line prior to the drying step and in other exemplary embodiments, the glass strands are incorporated into the carbon fiber processing line prior to the post-coat application step 24.

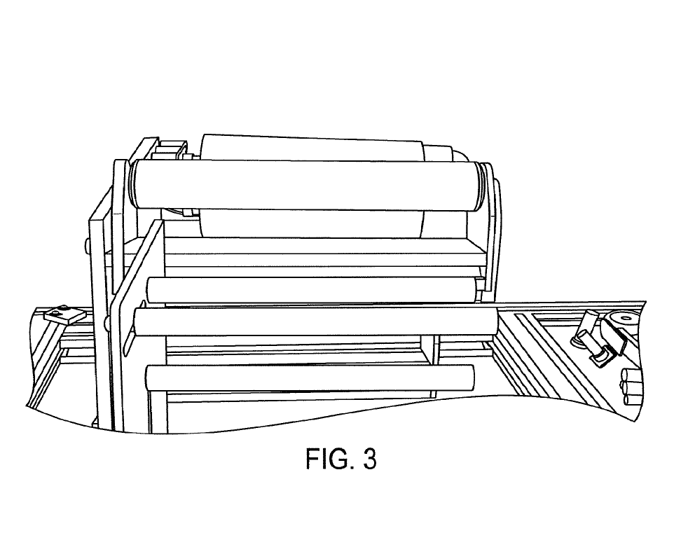

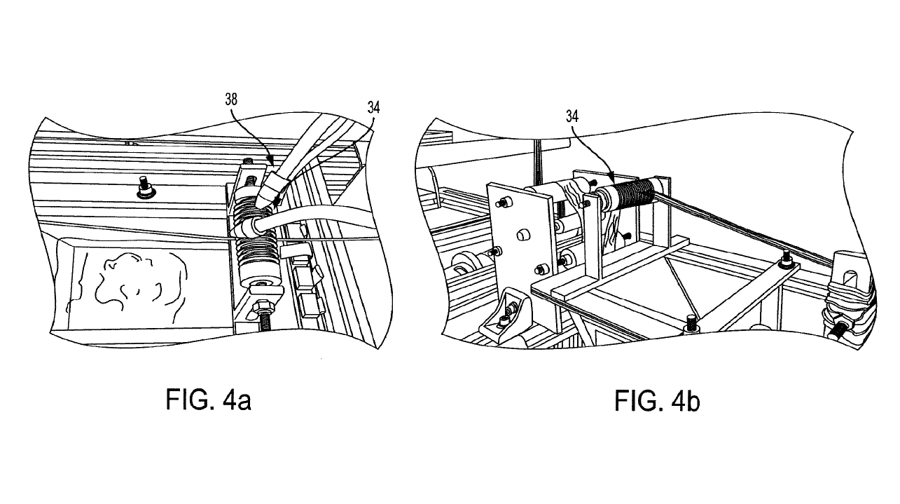

One difficulty in co-mingling glass and carbon fibers in a roving process is caused by the carbon fiber's tendency to agglomerate, which causes the fibers to clump together when chopping. Such agglomeration and clumping makes the carbon fiber difficult to disperse within a matrix resin material. Glass fibers are thin, rod-like fiber bundles having diameters of about 0.3 mm to about 1.2 mm. To effectively comingle the glass strands with the carbon, the carbon fiber strands should be sized and shaped similarly to the glass fiber strands. Accordingly, in some exemplary embodiments, prior to intermingling the glass fiber strands 12 and carbon fiber strands 14, the carbon fiber strands 14 are spread to disassociate individual carbon filaments and create into a plurality of thin bundles of about 50 tex to 800 tex (tex=grams/1000 m of tow), or from 50 tex to 400 tex, each having widths of between about 0.5 mm to about 4.0 mm, or between about 0.5 mm to 2.0 mm. The thin bundles may have a thickness of about 0.05 to about 0.5 mm, or from about 0.1 mm to about 0.3 mm. FIG. 3 illustrates an initial spreading station 25 where the carbon fibers are pulled under tension 2-4 times to spread the carbon fibers into thin bundles 22, as illustrated in FIGS. 4(a) and (b). The carbon fiber bundles 22 may then be pulled under tension to maintain consistent spreading and to further increase the spread between the bundles. For example, a plurality of carbon fiber bundles 22 having spreads of about ⅜″-about ½″ are pulled along a variety of rollers 16 under tension to form spreads between about ¾″ to about 1½″. The angles and radius of the rollers 16 should be set to maintain a tension that is not too high, which could pull the spread bundles back together.

In some exemplary embodiments, once the carbon fiber strands have been spread into thin carbon fiber bundles, the carbon fiber bundles 22 are pulled through a post-coat treatment bath 24 to consolidate the bundles for chopping and to improve the dispersion and solubility of the carbon fibers with the desired matrix material. By improving the matrix material compatibility, the fibers will wet more easily, which in turn may speed up the manufacturing time. In some exemplary embodiments, rather than being pulled through a post-coat treatment bath, the post-treatment may be applied by any known coating application method, such as kiss-coating or spraying the coating on the carbon bundles by one or more spraying device 38 or applied to the bundles using an applicator roll. In some exemplary embodiments, rather than coating the fiber strands with the post-coat composition after spreading the strands into bundles, the post-coat composition may be applied prior to the fiber bundles being spread. In other exemplary embodiments, the post-coat composition may be applied both before and after the fiber bundles are spread. In some exemplary embodiments, the carbon fiber input comprises a plurality of pre-formed thin carbon fiber bundles 22, and the post-coat composition may be applied to the bundles at any point during processing prior to co-mingling with the glass fiber strands.

In some exemplary embodiments, the post-coat treatment composition comprises at least one film former. For example, the post-treatment composition may comprise a polyvinylpyrrolidone (PVP) as a film forming binder and complexing agent due to its high polarity. In some exemplary embodiments, the post-treatment composition may comprise one or more silanes, such as acryl, alkyl, methyl, amino silane, and epoxy silane, to help compatibilize the carbon fiber with the matrix material. In other exemplary embodiments, the post-treatment composition comprises both a PVP and methyl silane. Additionally, the binding agent is run in combination with a quaternary amine for anti-static protection. In some exemplary embodiments the post-treatment composition includes one or more of a co-film former, a compatibilizer, and a lubricant.

In some exemplary embodiments, the post-coated carbon bundles are then pulled through an infrared oven 26, or other curing mechanism, to dry the post-coat treatment composition on the carbon bundles.

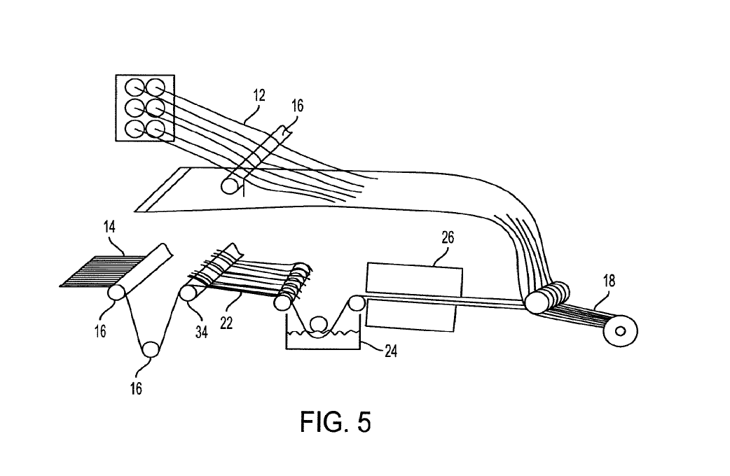

In some exemplary embodiments, such as is illustrated in FIG. 5, as the carbon fiber processing is occurring in-line, glass fiber strands 12 are simultaneously being pulled from glass fiber packages in parallel for comingling with the carbon fiber bundles 22 described above. In some exemplary embodiments, as the carbon fiber bundles 22 are pulled from the infrared oven 26, the carbon fiber bundles 22 are co-mingled with glass fibers 12, forming a hybrid assembled roving 28 of glass and carbon fibers. To form a cohesive hybrid roving, the width of glass fibers being pulled through the process should be consistent with the width of carbon fibers. For instance, if the width of glass fibers pulled through the process is 2 mm, then it the width of the carbon fiber bundles should also be about 2 mm with about a 1 mm margin of variance. As the glass and carbon fibers are condensed into a hybrid assembled roving, the width of the condensed hybrid fiber bundle may be lower, such as from about 0.5 mm to about 2.0 mm.

Typically, chopping carbon fibers filamentizes the carbon fibers, increasing the surface area of the fibers and increasing wetting and flow difficulties. By consolidating the carbon fibers into hybrid assembled rovings and chopping the hybrid roving into chopped hybrid fibers 30, the flow and dispersion of the carbon fibers are improved, since glass acts as a stabilizer for carbon and keeps it from filamentizing, thereby providing a homogeneous composite formation.

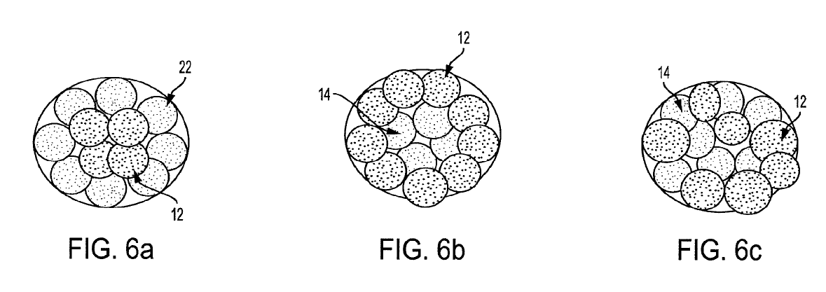

As illustrated in FIG. 6, the architecture of the hybrid assembled roving may be adjusted by varying the structure of the glass and carbon bundles therein and/or the weight ratio of the glass fibers to the carbon fibers. In some exemplary embodiments, the carbon fiber bundles 22 are arranged on the exterior of the hybrid bundle, with the glass fibers 12 disposed in the center of the bundle, as illustrated in FIG. 6(a). In other exemplary embodiments, the glass fibers are arranged on the exterior of the hybrid bundle, with the carbon fiber bundles 22 disposed in the center of the bundle, as illustrated in FIG. 6(b). In other exemplary embodiments, the glass fibers and carbon fiber bundles are dispersed randomly within the hybrid bundle, as illustrated in FIG. 6(c). In some exemplary embodiments, the glass and carbon fibers are dispersed within the hybrid bundle in a weight ratio of glass fiber to carbon fiber between about 10:90 and about 90:10, such as about 60:40 or about 75:25, or about 65:35. In some exemplary embodiments, the weight ratio of glass fiber to carbon fiber is about 50:50.

Once formed, the hybrid assembled roving may be wound or otherwise placed in a package and stored for downstream use, such as for compounding with a thermoplastic composition in a long fiber thermoplastic compression molding process. For the purposes of the present invention, the term long fiber thermoplastic material is a material including an initial glass fiber input that is longer than 4.5 mm. There are a variety of forming methods for long fiber thermoplastics, the most common being an extruded “charge” or pellet, wire coating, and direct compounding. Some aspects of the present invention are directed to forming an extruded hybrid assembled roving charge for use in a compression or injection molding process. In this process, as a thermoplastic polymer is introduced into an extruder, the hybrid assembled roving may be fed into the extruder nozzle (or side stuffer) where the roving is impregnated with the thermoplastic. The thermoplastic impregnated hybrid roving may then be extruded into a hybrid charge for use in a compression or injection molding process.

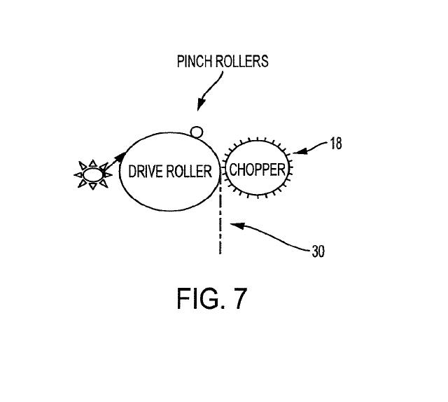

The hybrid assembled roving may alternatively be chopped for use in the formation of a reinforced composite. In some exemplary embodiments, the hybrid assembled roving may be chopped using a chopper roll 18, such as a bladed steel chopper roll pressed against a polyurethane or hard rubber drive roller 31, as illustrated in FIG. 7. The chopped hybrid fibers 30 may have an average length of about 10 mm to about 100 mm in length, or a length of about 11 to about 50 mm. In some exemplary embodiments, the chopped hybrid fibers have a length of about 25 mm.

The chopped hybrid fibers may have varying lengths and diameters. In some exemplary embodiments, the hybrid assembled roving comprises a mixture of chopped glass and carbon fibers. The particular length of the chopped fibers is based on the complexity of the molded part tooling to be used downstream, balanced with desired composite part performance.

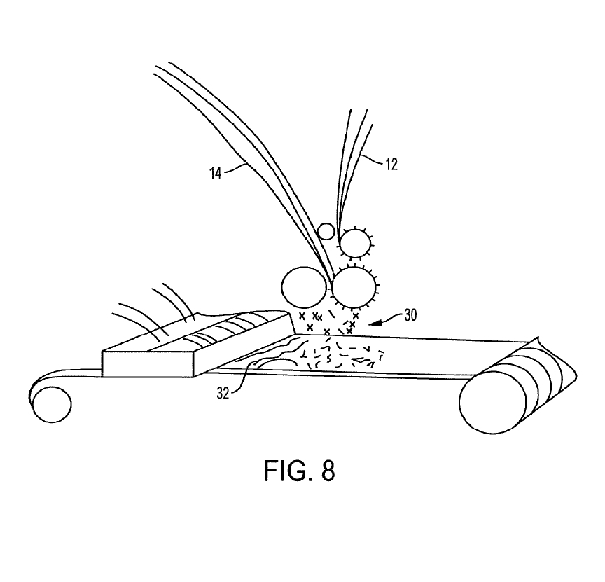

As noted above, the chopped hybrid fibers 30 may then be used in the formation of reinforcement materials, such as reinforced composites, prepregs, fabrics, nonwovens, and the like. In some exemplary embodiments, the chopped hybrid fibers 30 may be used in an SMC process, for forming an SMC material. As illustrated in FIG. 8, the chopped hybrid fibers 30 may be placed on a layer of a polymer resin film 32, which is positioned on a carrier sheet that has a non-adhering surface. A second, non-adhering carrier sheet containing a second layer of polymer resin film may be positioned onto the chopped hybrid fibers 30 in an orientation such that the second polymer resin film 32 contacts the chopped hybrid fibers 30 and forms a sandwiched material of polymer resin film-chopped hybrid fiber-polymer resin film 32. This sandwiched material may then be kneaded with rollers such as compaction rollers to substantially uniformly distribute the polymer resin matrix and hybrid fiber bundles throughout the resultant SMC material. As used herein, the term “to substantially uniformly distribute” means to uniformly distribute or distribute greater than 50% uniformly. In some exemplary embodiments, “substantially uniformly distributes” means to distribute about 90% uniformly. The SMC material may then be stored for 2-5 days to permit the resin to thicken and mature. During this maturation time, the SMC material increases in viscosity within the range of about 15 million centipoise to about 40 million centipoise. As the viscosity increases, the first and second polymer resin films 32 and the chopped hybrid fibers 30 form an integral composite layer.

The polymer resin film material may comprise any suitable thermoplastic or thermosetting material, such as polyester resin, vinyl ester resin, phenolic resin, epoxy, polyamide, polyimide, polypropylene, polyethylene, polycarbonate, polyvinyl chloride, and/or styrene, and any desired additives such as fillers, pigments, UV stabilizers, catalysts, initiators, inhibitors, mold release agents, thickeners, and the like. In some exemplary embodiments, the thermosetting material comprises a styrene resin, an unsaturated polyester resin, or a vinyl ester resin. In structural SMC applications, the polymer resin film 32 may comprise a liquid, while in Class A SMC applications, the polymer resin film may comprise a paste.

The post-coat treatment composition applied to the carbon fibers compatibilizes the carbon fibers with the polymer resin film and allows the carbon fibers to flow and wet properly, forming a substantially homogenous dispersion of glass and carbon fibers within the polymer resin film 32. The post-coat treatment also imparts increased cohesion, which allows for good chopping of the fibers and improved wetting in the consolidation process. Faster wetting of the carbon fibers results in greater in-line productivity and the ability to produce a larger amount of SMC material per hour. In addition, faster wetting of the glass fibers results in an SMC material that contains fewer dry glass fibers. Fewer dry glass fibers in the SMC material in turn results in a reduction in the number of defects that may occur during the molding of the composite part and a reduction in the manufacturing costs relative to the production of composite parts formed from only glass fibers.

Once the SMC material has reached the target viscosity, the SMC material may be cut and placed into a mold having the desired shape of the final product. The mold is heated to an elevated temperature and closed to increase the pressure. This combination of high heat and high pressure causes the SMC material to flow and fill out the mold. The matrix resin then goes through a period of maturation, where the material continues to increase in viscosity as a form of chemical thickening or gelling. Exemplary molded composite parts formed using hybrid assembled rovings may include exterior automotive body parts and structural automotive body parts.

The molded composite parts may contain approximately 10% to about 80% by weight hybrid assembled roving material, chopped or otherwise incorporated. When forming Class A composites, some exemplary embodiments will include about 15% to about 40% by weight hybrid assembled roving material. When forming a structural composite, some exemplary embodiments will include about 35% to about 75% by weight hybrid assembled roving material.

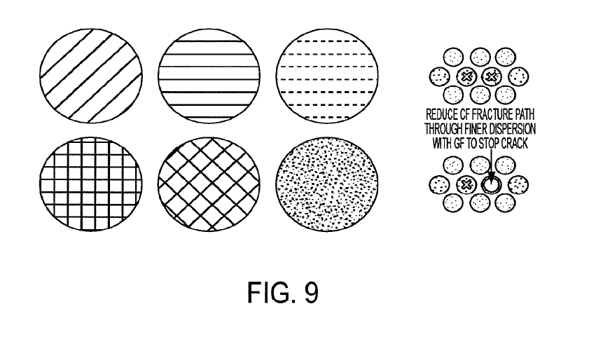

Including a hybrid of glass and carbon fibers in composite materials allows for the production of material that is about 15% to about 50% lighter weight and about 20% to about 200% stronger than otherwise identical composite materials that include only glass fiber reinforcements. This improvement increases with greater dispersion both at the strand level and by layers through the thickness of a composite, as illustrated in FIG. 9. By finely distributing the carbon fibers throughout the composite, the potential fracture path of a stressed carbon fiber will be reduced by the presence of a glass fiber nearby. The toughness of the glass fibers help redistribute the load from a stressed carbon fiber. This will delay fracture development by reducing fracture crack initiation sites and slowing failure development.

Additionally, a hybrid glass and carbon reinforced composite utilizes the electrical conductivity of carbon for additional product improvements, such as a grounding means for painting processes, electrical shorts in automotive parts, and for electromagnetic interference “EMI” shielding. The homogenously dispersed carbon fibers create an effective faraday cage throughout a composite part by creating a self-reinforcing network with an orientation conducive to percolation.

In some exemplary embodiments, hybrid SMC materials formed using the hybrid reinforced materials disclosed herein have an elastic modulus of between about 5 GPa and about 40 GPa, or from about 10 GPa to about 30 GPa, or from about 15 GPa to about 20 GPa. In other exemplary embodiments, the hybrid SMC material has an elastic modulus of about 12 GPa to about 17 GPa, or about 15 GPa.

In some exemplary embodiments, hybrid SMC materials formed using the hybrid reinforced materials disclosed herein have a dry interlaminar shear strength of between about 50 MPa and about 300 MPa, or from about 70 MPa to about 80 MPa. In other exemplary embodiments, the resulting hybrid SMC material has a dry interlaminar shear strength of about 72 MPa and about 78 MPa, or about 75 MPa.

In some exemplary embodiments, hybrid SMC materials formed using the hybrid reinforced materials disclosed herein have a density of between about 0.5 g/cc and about 3.0 g/cc, or from about 0.75 glee to about 2.5 g/cc. In other exemplary embodiments, the resulting hybrid SMC material has a density of about 1.0 g/cc to about 1.5 g/cc, or about 1.08 g/cc.

In some exemplary embodiments, hybrid LFT materials formed using the hybrid reinforced materials disclosed herein have a tensile strength of greater than 150 MPa. In some exemplary embodiments, hybrid LFT materials have a tensile strength of between about 160 MPa and about 300 MPa. In some exemplary embodiments, hybrid LFT materials formed using the hybrid reinforced materials disclosed herein have a tensile modulus of greater than 15 GPa. In some exemplary embodiments, hybrid LFT materials have a tensile modulus of between about 19 GPa and about 28 GPa, or between about 21 GPa to about 25 GPa.

Additionally, the use of hybrid reinforcement fibers in LFT materials helps to overcome the challenges that carbon fibers pose to LFT processes. Particularly, as carbon fibers are more thermally conductive than glass fibers, the carbon fibers tend to cool too quickly after being injected into a mold. By comingling the glass fibers and carbon fibers, the glass fibers work to insulate the carbon fibers enabling better flow to uniformly fill out a mold part for increased yield.

Having generally described various aspects of the general inventive concepts, a further understanding can be obtained by reference to certain specific examples illustrated below which are provided for purposes of illustration only and are not intended to be all inclusive or limiting unless otherwise specified.

### Examples

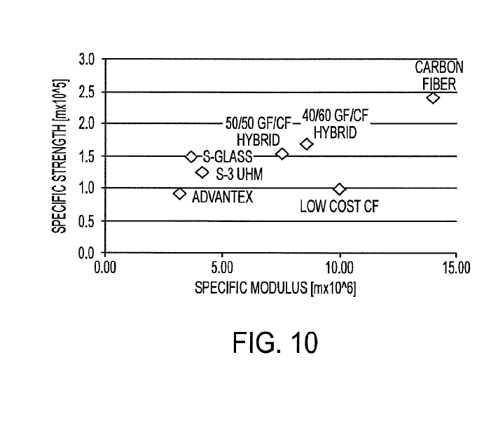

FIG. 10 illustrates the specific strength of various reinforcement fibers versus the specific modulus of the fibers. As illustrated, conventional reinforcement material, particularly glass fibers, demonstrates a specific strength of about 0.9×10⁵ m to 1.5×10⁵ and a specific modulus of less than 5×10⁶ m. Carbon fibers, on the other hand, demonstrate higher specific strengths and specific modulus, at about 2.4×10⁵ m and 14.0×10⁶ m, respectively. In contrast, both the 50/50 hybrid glass and carbon fiber and the 40/60 hybrid glass and carbon fiber demonstrate improved properties over glass fibers alone. The specific strength increased to between 1.5 and 1.7×10⁵ m and the specific modulus increased to about 7.5 and 9.0×10⁶ m. Accordingly, hybrid fiber reinforcements provide an improvement over glass fiber reinforcements without all the cost and processing issues associated with manufacturing carbon fiber reinforcements.

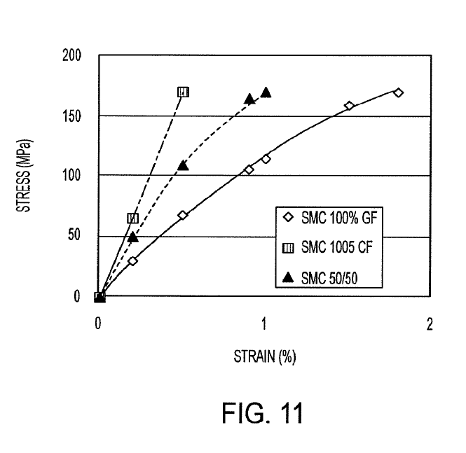

FIG. 11 illustrates a stress-strain curve for three SMC materials, one including only glass fiber reinforcements, one including only carbon fiber reinforcements, and one including hybrid assembled roving reinforcements having 50:50 glass to carbon ratio. As illustrated in FIG. 11, when exposed to the same stress load, glass fiber reinforced SMC demonstrate the largest strain (elongation) percentage, while still being able to return to its original form. In contrast, carbon fibers exhibit a low strain elongation under the same amount of stress. The composite formed using the hybrid assembled roving reinforcements demonstrates a strain percentage that falls between that of using carbon fiber or glass fiber alone.

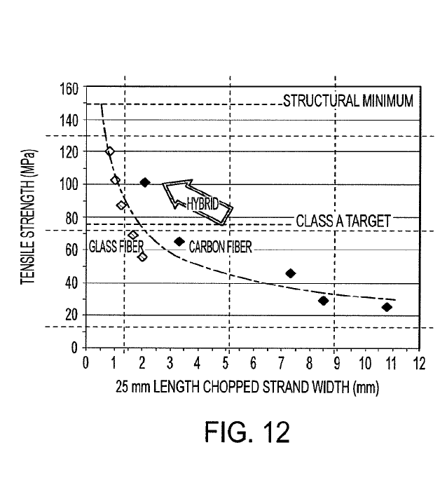

FIG. 12 demonstrates the tensile strength of an exemplary hybrid SMC material compared to both glass and carbon reinforced SMC material, as a function of the chopped strand widths. As demonstrated in FIG. 12, as the width of the strands increases, the tensile strength of the SMC material drops. For a structural SMC material, the width of the hybrid assembled roving should be less than about 1 mm, such as about 0.5 mm or below. For Class A SMC material, the widths of the hybrid assembled roving may be less than about 2 mm.

Table 1 illustrates the properties achieved using hybrid reinforcement material of the present inventive concepts in long fiber thermoplastic composites. Examples 1 and 2 utilize a hybrid assembled glass and carbon comingled long fiber tow that has been impregnated with a PA-6,6 matrix resin. Comparative Example 1 is a glass-only composite that utilizes a multi-end glass fiber roving. Comparative Example 2 is a conventional hybrid multi-end glass and carbon fiber that is formed by running packages of carbon and glass side by side without comingling the fibers. Conventional hybrid LFT composites include parallel glass and carbon fibers, but the glass and carbon fibers are not comingled into a single roving and are rather maintained as separate fibers. Examples 1 and 2 were prepared using a hybrid reinforcement material according to the present inventive concepts. The carbon fibers used in the formation of the LFT composite material in Example 1 were coated with a 3.5 weight percent PVP post-coating composition and the carbon fibers used in the formation of the LFT composite material in Example 2 were coated with 3.5 weight percent of a post-coating composition including PVP and a mixture of 50% A-1100 and 50% A-174.

TABLE 1

| LFT PA66 | | | | |
|---|---|---|---|---|
| Composite | Comp. Ex. 1 | Comp. Ex. 2 | Example 1 | Example 2 |
| Fiber weight | 50.3% | 55.5% | 49.8% | 49.3% |
| (%) | | | | |
| Specific | 1.62 | 1.55 | 1.49 | 1.42 |
| Gravity | | | | |
| Hybrid fiber | 100/0 | 64/36 | 65/35 | 65/35 |
| ratio (GF:CF) | | | | |
| Tensile | 176 | 203 | 163 | 280 |
| Strength | | | | |
| (MPa) | | | | |
| Tensile | 14 | 18 | 21.7 | 22.5 |
| Modulus | | | | |
| (GPa) | | | | |
| Flexural | 253 | 333 | 311 | 350 |
| Strength | | | | |
| (MPa) | | | | |
| Flexural | 13.2 | 18.6 | 21.5 | 21.9 |
| Modulus | | | | |
| (GPa) | | | | |
| Un-notched | 94.7 | 95.1 | 364 | 420 |
| impact | | | | |
| strength (J/m) | | | | |
| Notched | 253 | 138 | 150 | 135 |
| Impact | | | | |
| strength (J/m) | | | | |
| Tensile | 97.3 | 120 | 90.9 | 180 |
| strength aged | | | | |
| hot/wet | | | | |
| (MPa) | | | | |
| Tensile | 8.3 | 10.9 | 11.9 | 14.6 |
| modulus aged | | | | |
| hot/wet (GPa) | | | | |

As illustrated above, LFT composites formed using the hybrid reinforcement materials disclosed herein demonstrate higher performance properties than both glass LFT composites and conventional, non-comingled hybrid LFT composites. Specifically, Examples 1 and 2 are lighter (as demonstrated by weight % of the LFT composite) and have a lower specific gravity than both Comparative Example 1 and 2. Additionally, Examples 1 and 2 have high tensile and flexural strengths (greater than 160 MPa) and tensile and flexural modulus greater than that seen in either the glass LFT composite or the conventional, non-comingled hybrid LFT composite (greater than 21 GPA). The un-notched and notched impact strengths listed in Table 1 illustrate comparative values for the impact strength of a plastic composite. The notched impact strength is determined by notching the composite to a depth of 2 mm and dropping a hammer onto the composite to break it. The difference in the hammer's energy at impact and after the breakage indicates the impact energy absorbed by the composite. As illustrated above, Examples 1 and 2 illustrate un-notched impact strengths that are significantly higher than either Comparative Example 1 or 2.

Although embodiments of the invention have been described herein, it should be appreciated that many modifications can be made without departing from the spirit and scope of the general inventive concepts. All such modifications are intended to be included within the scope of the invention, which is to be limited only by the following claims.

1. A hybrid long fiber thermoplastic composite comprising:
a thermoplastic material; and
a hybrid assembled roving fully impregnated with said thermoplastic material, said hybrid assembled roving comprising:
a plurality of reinforcement fibers and a plurality of carbon fibers, said reinforcement fibers and said carbon fibers being comingled to form a unitary strand, wherein said carbon fibers are coated with a compatibilizer.

2. The hybrid long fiber thermoplastic material of claim 1, wherein the reinforcement fibers comprise at least one of glass fibers, aramid fibers, and high modulus organic fibers.

3. The hybrid long fiber thermoplastic material of claim 1, wherein the reinforcement fibers consist of glass fibers.

4. The hybrid long fiber thermoplastic material of claim 1, wherein the compatibilizer comprises at least one of polyvinylpyrrolidone (PVP), methyl silane, amino silane, and epoxy silane.

5. The hybrid long fiber thermoplastic material of claim 1, wherein said hybrid long fiber thermoplastic material is in the form of chopped pellets having a length of about 10 to 12 mm.

6. The hybrid long fiber thermoplastic material of claim 1, wherein said carbon fibers have a density of 50 tex to 800 tex and a width of 0.5 mm to 4 mm.

7. The hybrid long fiber thermoplastic material of claim 1, wherein the hybrid reinforcement material has a width of 0.5 mm to 2 mm.

8. The hybrid long fiber thermoplastic material of claim 3, wherein a weight ratio of the glass fibers to the carbon fibers is within the range of 10:90 to 90:10.

9. The hybrid long fiber thermoplastic material of claim 1, wherein the hybrid reinforcement material has a specific strength of 1.0×10⁵ m to 2.0×10⁵ m.

10. The hybrid long fiber thermoplastic material of claim 1, wherein the hybrid reinforcement material has a specific modulus of 7.0×10⁶ m to 14.0×10⁶ m.

11. The hybrid long fiber thermoplastic material of claim 1, wherein said hybrid long fiber thermoplastic material has a tensile strength of greater than 150 MPa.

12. The hybrid long fiber thermoplastic material of claim 1, wherein said hybrid long fiber thermoplastic material has a tensile modulus of greater than 15 GPa.

13. An extruded hybrid charge for use in a compression molding process comprising the hybrid long fiber thermoplastic material of claim 1.

14. A method of forming a hybrid long fiber thermoplastic material, the method comprising:
comingling a plurality of reinforcement fibers and a plurality of carbon fibers to form a hybrid assembled roving, said carbon fibers being previously coated with a sizing composition and then are post-coated with a compatibilizer;
impregnating said hybrid assembled roving with a thermoplastic material, forming a thermoplastic impregnated hybrid roving; and
extruding the thermoplastic impregnated hybrid roving into a hybrid charge for use in at least one of compression molding and injection molding process.

15. The method of claim 14, wherein said hybrid charge comprises a plurality of chopped pellets having a length of about 10 to 12 mm.

16. The method of claim 14, wherein the reinforcement fibers comprise at least one of glass, aramid, and high modulus organic fibers.

17. The method of claim 14, wherein the reinforcement fibers consist of glass fibers.

18. The method of claim 14, wherein thermoplastic material comprises at least one of a polyamide, polyimide, polypropylene, polyethylene, polycarbonate, polyvinyl chloride, and/or styrene, and co-monomers.

19. The method of claim 14, wherein the compatibilizer comprises at least one of polyvinylpyrrolidone (PVP), methyl silane, amino silane, and epoxy silane.

20. The method of claim 14, wherein said carbon fibers have a density of 50 tex to 800 tex and a width of 0.5 mm to 4 mm.

21. The method of claim 14, wherein the hybrid assembled roving has a width of 0.5 mm to 2 mm.

22. The method of claim 17, wherein a weight ratio of the glass fibers to the carbon fibers is within the range of 10:90 to 90:10.

23. The method of claim 14, wherein the hybrid assembled roving has a specific strength of 1.0×10⁵ m to 2.0×10⁵ m.

24. The method of claim 14, wherein the hybrid assembled roving has a specific modulus of 7.0×10⁶ m to 14.0×10⁶ m.

25. The method of claim 14, wherein said hybrid long fiber thermoplastic material has a tensile strength of greater than 150 MPa.

26. The method of claim 14, wherein said hybrid long fiber thermoplastic material has a tensile modulus of greater than 15 GPa.
